(19) United States
(12) Patent Application Publication
(10) Pub. No.: US 2013/0080518 A1
(43) Pub. Date: Mar. 28, 2013

(54) WEB PAGE SUPPLYING SYSTEM, WEB PAGE SUPPLYING METHOD, AND RECORDING MEDIUM WITH CONTROL PROGRAM STORED THEREIN

(71) Applicants: Tomotaka Shionoya, Yokohama (JP); Masashi Egi, Machida (JP); Tomohiro Nakamura, Hachioji (JP)

(72) Inventors: Tomotaka Shionoya, Yokohama (JP); Masashi Egi, Machida (JP); Tomohiro Nakamura, Hachioji (JP)

(73) Assignee: Hitachi Ltd

(21) Appl. No.: 13/701,964

(22) PCT Filed: Aug. 27, 2010
(86) PCT No.: PCT/JP2010/064584

§ 371 Date: Dec. 4, 2012

(30) Foreign Application Priority Data
Jun. 11, 2010 (JP) 2010 133719

(51) Int. Cl. G06F 15/16

(52) U.S. Cl. 709/203

(57) ABSTRACT

Disclosed is a web page supplying system provided with a web server and a management server, wherein the web server has stored therein control information indicating whether to insert adding information into a web page requested by a client apparatus, refers to the stored control information when receiving a browsing request, evaluates whether to insert the adding information into the web page to be transmitted to the client apparatus requesting the web page, and controls, when an evaluation is made not to insert the adding information into the web page, an adding information inserting means such that the adding information is not inserted into the web page.

### BACKGROUND OF THE INVENTION

This invention relates to a computer system in which a server device supplies a Web page by transmitting the Web page to a client device, and more particularly, to a computer system for transmitting a Web page into which additional information to be applied by the client device is inserted.

In recent years, a sales system of software is gradually shifting from a sales of a package such as in a CD-ROM to a sales of a service via a network (SaaS: Software as a Service).

As more programs are supplied as Web applications using a function of a Web, more importance is given to extending or changing functions of a Web application by means of mash-up, which combines a plurality of applications.

The mash-up includes, in addition to the functional extension of a Web application by the cooperation of a plurality of Web applications stored in the server device, a functional extension of a Web application by an operation of a program on a client device.

Particularly, there has been developed a function extension method involving transmitting, by a server device, a small-scale program (hereinafter simply referred to as script) described in a script language such as JavaScript to a client device in order to omit an installation operation of a program on the client device.

Today, the script is used in various Web applications, and when a new script is added to a Web application by means of the mash-up, scripts may interfere in one another to cause an unexpected failure.

In order to address this problem, there is known a technology of controlling, by a client device, by using running permission information corresponding to a part or whole of each of scripts to be added to a Web application, whether or not each of the script is to be run (for example, refer to PTL 1).
[PTL 1] Japanese Patent Application Laid-open No. 2009-223555

### SUMMARY OF INVENTION

PTL 1 describes a configuration in which the client device controls whether or not a script is to be run only at a timing when the client device loads a Web page by a Web access from the client device to a server device.

However, after the script is loaded on the client device, in a case where the running permission information is updated, the permission for the running of the loaded script is not updated, and hence this configuration lacks timeliness of the update of whether the running of the script is permitted or not in response to the update of the running permission information.

Therefore, according to the invention described in PTL 1, the update of the running of the script in response to the update of the running permission information lacks timeliness, and hence a delay occurs in handling a case where an error occurs in a Web application. This leads to losses in time and money of a user of the Web application.

This invention has been made in view of above-mentioned problem, and therefore has an object to provide a Web page supplying system enabling timely update of running of a script in response to an update of the running permission information of the script.

A representative example of this invention is as follows. A Web page supplying system, comprising: a Web server for supplying a Web page by transmitting the Web page to a client device; and a management server for managing the Web server, wherein: the Web server stores control information indicating whether to insert additional information into the Web page requested by the client device, and includes: a Web page supplying module for supplying the Web page by transmitting the Web page requested by the client device to the client device; an additional information insertion module for inserting the additional information into the Web page requested by the client device; and a control module for controlling the additional information insertion module; the management server includes a management module for editing the control information stored in the Web server; and the control module is configured to: determine, by referring to the control information, whether to insert the additional information into the Web page to be transmitted to the client device requesting the Web page; and control, in a case where it is determined that the additional information is not to be inserted into the Web page, the additional information insertion module so as not to insert the additional information into the Web page.

According to an embodiment of this invention, the Web page supplying system enabling, in response to an update of additional information, which is running permission information, a timely update of an operation based on the additional information can be provided.

### BRIEF DESCRIPTION OF THE DRAWINGS

FIG. 1A is an explanatory diagram of a configuration of a Web page supplying system according to a first embodiment of this invention.

FIG. 1B is an explanatory of configuration of a management device according to the first embodiment of this invention.

FIG. 1C is an explanatory of configuration of a client device.

FIG. 2 is a sequence diagram for Web page supplying processing in the Web page supplying system according to the first embodiment of this invention.

FIG. 3 is an explanatory diagram of a control information storage area according to the first embodiment of this invention.

FIG. 4 is an explanatory diagram of a control information storage area according to a second embodiment of this invention.

FIG. 5 is a sequence diagram for Web page supplying processing in a Web page supplying system according to the second embodiment of this invention.

FIG. 6 is an explanatory diagram of a reload permission interface according to the second embodiment of this invention.

FIG. 7 is a sequence diagram for Web page supplying processing in a Web page supplying system according to a third embodiment of this invention.

FIG. 8 is an explanatory diagram of a configuration of the Web page supplying system according to a fourth embodiment of this invention.

FIG. 9 is an explanatory diagram of a log storage area according to the fourth embodiment of this invention.

FIG. 10 is a sequence diagram for Web page supplying processing in a Web page supplying system according to the fourth embodiment of this invention.

### DETAILED DESCRIPTION OF THE EMBODIMENT

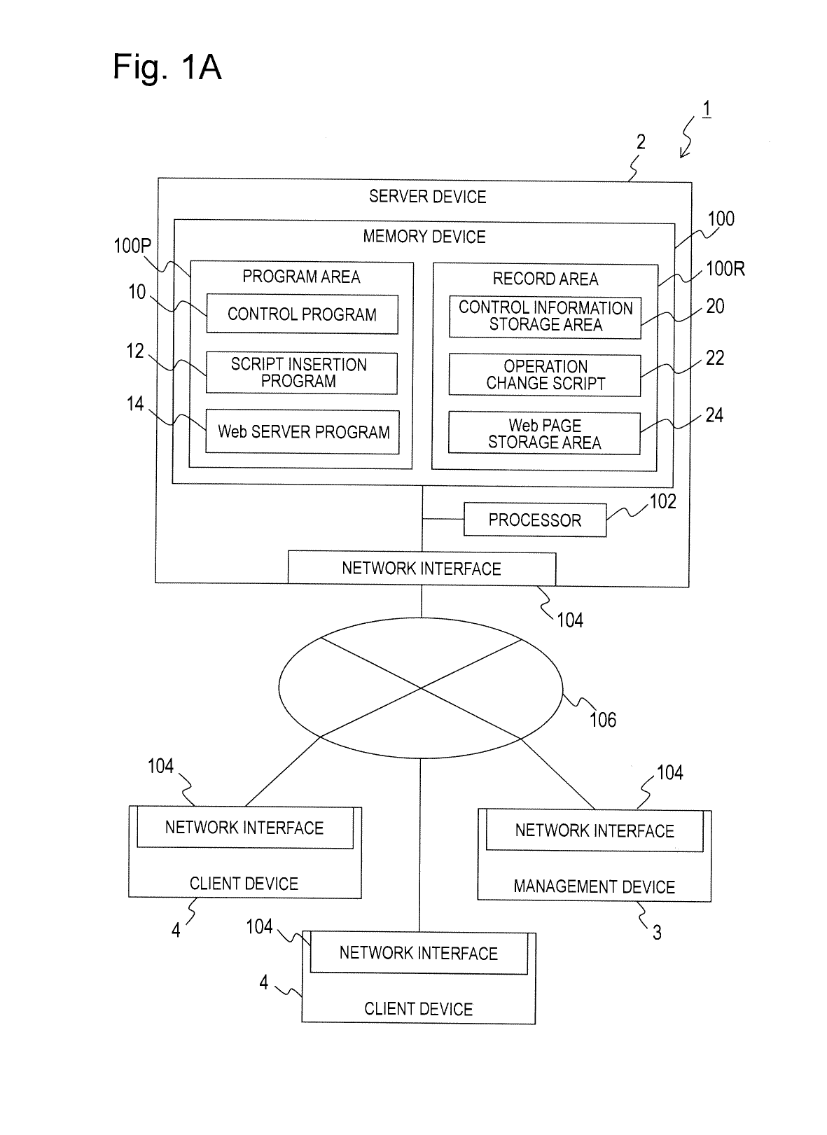

A description is now given of first to fourth embodiments of this invention by referring to FIGS. 1A to 10.

### First Embodiment

A description is now given of the first embodiment of this invention referring to FIGS. 1A to 3.

FIG. 1A is an explanatory diagram of a configuration of a Web page supplying system 1 according to the first embodiment of this invention.

The Web page supplying system 1 includes a server device 2 for supplying a Web page 24 by transmitting the Web page 24 to a client device 4, a management device 3 for managing the server device 2, and the client devices 4 for browsing or using the Web page 24. The server device 2, the management device 3, and the client devices 4 are coupled to each other via a network 106 for communication. The network 106 realizes transmission/reception of data by a predetermined protocol, and is, for example, a local area network (LAN), a wide area network (WAN), or the like.

First, a detailed description is given of the server device 2.

The server device 2 includes a memory device 100 for storing various programs and various information, a network interface 104 for enabling the server device 2 to be coupled to the management device 3 and the client devices 4 via the network 106 for communication, and a processor 102 for controlling, by executing programs stored in the memory device 100, the memory device 100 and the network interface 104.

The memory device 100 is constituted by a main memory device (such as DRAM) for storing programs and information to which the processor 102 needs to make a fast access and an auxiliary memory device (such as HDD, SSD, and EEPROM) for storing programs and information in a non-volatile manner.

A storage area of the memory device 100 includes a program area 100P which is a area for storing the programs, and a storage area 100R which is a area for storing information other than the programs. However, those storage areas 100P and 100R may not be formed by segmentation or partitioning on the storage area of the memory device 100.

The program area 100P stores a control program 10, a script insertion program 12, and a Web server program 14.

The control program 10 controls an insertion of an operation change script 22 (additional information) into a Web page 24 transmitted to the client device 4. The script insertion program 12 transmits, to the client device 4, the Web page 24 corresponding to a Web page browsing request transmitted by the client device 4. It should be noted that, into the Web page 24, the operation change script 22 may be inserted.

The Web server program 14 transmits the Web page 24 corresponding to the Web page browsing request transmitted to the server device 2 by the client device 4.

The storage area 100R stores operation change scripts 22 and Web pages 24. Moreover, the storage area 100R includes a control information storage area 20.

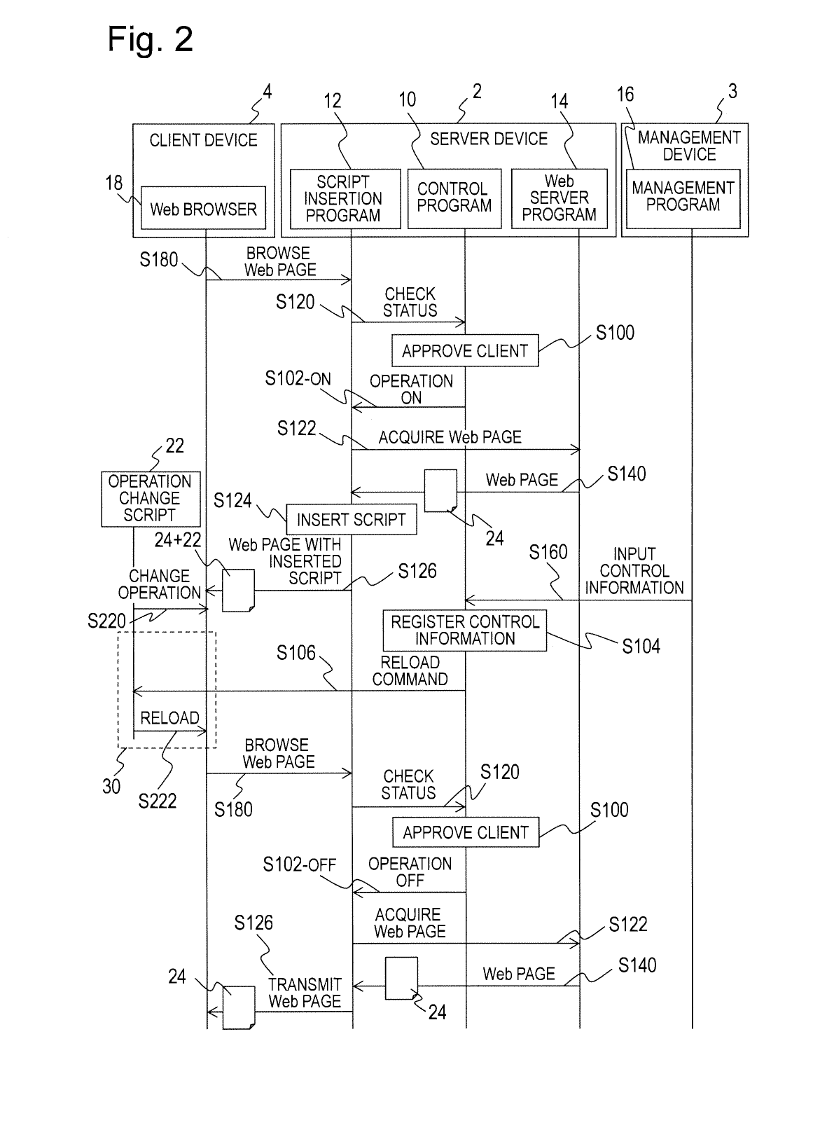

The control information storage area 20 stores permission range information 200 (refer to FIG. 3) used by the control program 10 for controlling the script insertion program 12. To the permission range information 200, information used to determine whether or not an operation change script 22 is to be inserted in response to the Web page browsing request from the client device 4 is registered.

The operation change script 22 is a script for extending functions of Web applications by means of the mash-up which combines a plurality of Web services, and is inserted into the Web page 24 by the script insertion program 12.

The Web page 24 is data transmitted, by the server device 2, in response to the Web page browsing request from the client device 4.

A detailed description is now given of the control program 10, the script insertion program 12, and the Web server program 14.

When a management program 16 receives an input to update the permission range information 200 from an administrator, the management program 16 notifies the control program 10 of a received input content to update the permission range information 200. The control program 10, which has been notified of the input content, updates the permission range information 200 based on the input content.

Moreover, the script insertion program 12 inquires of the control program 10 whether or not, into the Web page 24 to be transmitted in response to the Web page browsing request from the client device 4, the operation change script 22 is to be inserted. When the control program 10 receives the inquiry from the script insertion program 12, the control program 10 refers to the control information, determines whether the operation change script 22 is to be inserted into the Web page 24 to be transmitted to the client device 4 which has transmitted the Web page browsing request, and notifies the script insertion program 12 of a determination result.

The script insertion program 12 interrupts processing of transmitting, by the Web server program 14, the Web page 24, and inserts the operation change script 22 into the Web page 24.

The Web server program 14 transmits, to the client device 4, the Web page 24 corresponding to the Web page browsing request from the client device 4. Moreover, the Web server program 14 may transmit, without receiving a Web page browsing request, a Web page 24 generated by the Web server program 14 itself to the client device 4.

The network interface 104 converts information transmitted/received between the server device 2 and another device into information compliant with the protocol suited to the network 106. The network interface 104 manages a MAC address for uniquely identifying the network interface 104, a network address (such as an IP address) for uniquely identifying the server device 2 in the network 6, and a session ID for uniquely identifying a communication session between the server device 2 and another device.

A detailed description is now given of the management device 3 referring to FIG. 1B.

The management device 3 includes, in the same manner as the server device 2, the memory device 100, the processor 102, and the network interface 104.

In the memory device 100, the management program 16 for managing the server device 2 is stored.

The management program 16 communicates to/from the control program 10 of the server device 2, and edits the permission range information 200 stored in the server device 2.

If the server device 2 and the management device 3 include dedicated interfaces, the server device 2 and the management device 3 do not need to communicate via the network 106, and can communicate to/from each other via the direct coupling between the server device 2 and the management device 3.

Moreover, if the management program 16 is stored in the memory device 100 of the server device 2, the server device 2 and the management device 3 may be implemented on the same device. Further, if the management program 16 is stored in the memory device 100 of the client device 4, the client device 4 and the management device 3 may be implemented on the same device.

It should be noted that, in FIG. 1A, the communication between the server device 2 and the management device 3 is carried out via the network 106.

A detailed description is now given of the client device 4 referring to FIG. 1C.

The client device 4 includes, in the same manner as the server device 2 and the management device 3, the memory device 100, the processor 102, and the network interface 104.

The memory device 100 stores a Web page browsing program 27 and a script execution program 28.

The Web page browsing program 27 displays the Web page 24 transmitted by the server device 2. The script execution program 28 interprets the operation change script 22 inserted into the Web page 24, and executes processing specified by the operation change script 22.

It should be noted that the Web page browsing program 27 and the script execution program 28 are generally included in the Web browser 18. Therefore, according to this embodiment, a description is given of a combination of the Web page browsing program 27 and the script execution program 28 as the Web browser 18.

Each of the devices 2 to 4 illustrated in FIG. 1A can be constituted by a personal computer. The personal computer generally includes an input device (such as a keyboard and a mouse) and an output device (such as a display), but according to this embodiment, the server device 2 and the management device 3 may not include an input device and an output device, and a description of the input device and the output device is therefore omitted.

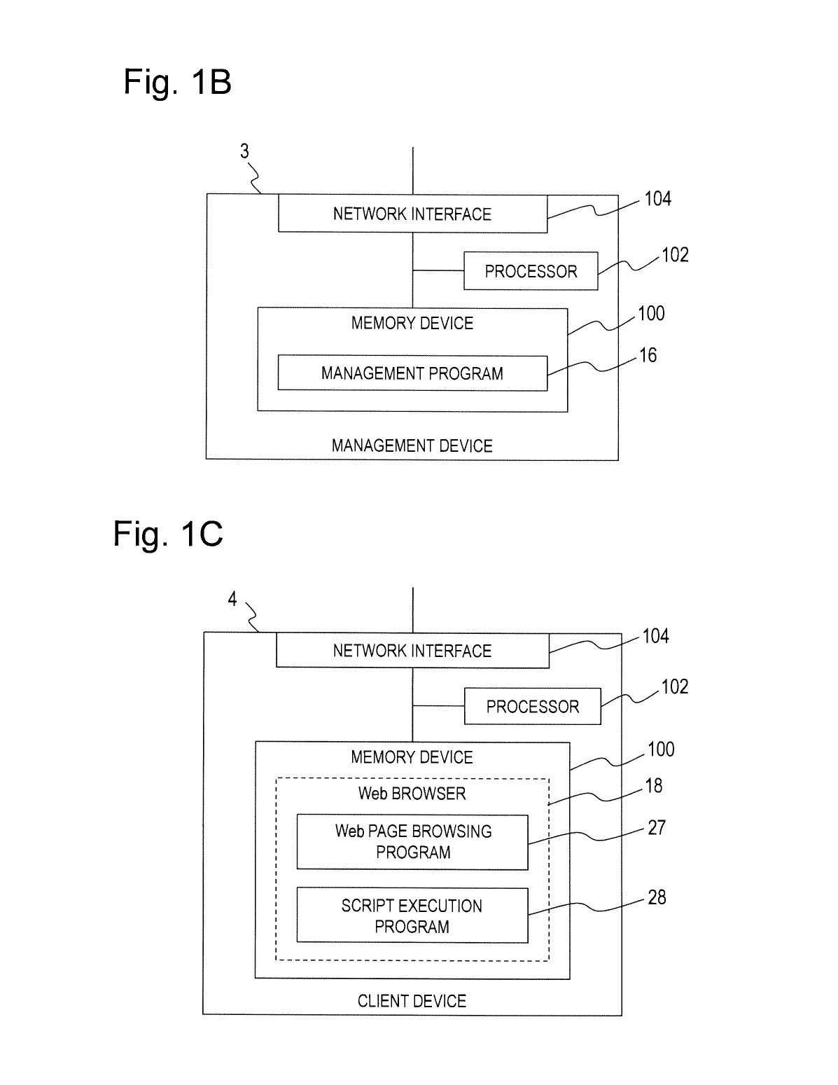

FIG. 2 is a sequence diagram for Web page supplying processing in the Web page supplying system 1 according to the first embodiment of this invention.

In FIG. 2, from the top to the bottom, an elapse of time is indicated, and horizontal arrows indicate communication between the respective programs. Out of both ends of the arrow, one end provided with an arrow head indicates a transmission destination of information, and the other end without the arrow head indicates a transmission source of the information.

First, a description is given of a sequence until the Web page 24 is provided.

First, the Web browser 18 of the client device 4 transmits a Web page browsing request to the Web server program 14 of the server device 2 (S180).

The Web page browsing request is a request to specify the Web page 24 supply of which is requested by a user of the client device 4, and includes information on the type of the Web browser 18, version information on the Web browser 18, and information which can identify the client device 4 of the transmission source (transmission source information) as additional information. The transmission source information includes, for example, a session ID of the communication between the client device 4 and the server device 2, the IP address of the client device 4, and the MAC address of the client device 4 (network interface 104).

When the script insertion program 12 receives the Web page browsing request transmitted by the client device 4, the script insertion program 12 extracts the transmission source information from the received Web page browsing request, and inquires of the control program 10 whether or not the operation change script 22 is to be inserted into the Web page 24 to be transmitted to the client device 4 identified by the extracted transmission source information (S120).

The control program 10 carries out client approval processing of determining whether or not to control the script insertion program 12 to insert the operation change script 22 into the Web page 24 based on the transmission source information and the permission range information 200 (refer to FIG. 3) (S100).

Referring to FIG. 3, a detailed description is now given of the permission range information 200. FIG. 3 is an explanatory diagram of the control information storage area 20 according to the first embodiment of this invention.

The permission range information 200 includes operation modes 202, determination items 204, and determination values 206. A combination of the determination item 204 and the determination value 206 is referred to as determination information 207.

To the operation mode 202, information indicating whether or not the insertion of an operation change script 22 into the Web page 24 to be transmitted to the client device 4 or the session matching the determination information 207 is permitted is registered. When ON is registered to the operation mode 202, this registration indicates that the insertion of the operation change script 22 into the Web page 24 is permitted, and when OFF is registered to the operation mode 202, this registration indicates that the insertion of the operation change script 22 into the Web page 24 is prohibited.

To the determination item 204, information indicating which type of transmission source information the value registered to the determination value 206 indicates is registered. In other words, the determination item 204 is used to determine which value out of the input content of the permission range information 200 notified by the control program 10 is used to identify a client device 4 or a session.

To the determination information 204, a session ID, an IP address, or a MAC address included in the transmission source information can be registered. Moreover, to the determination item 204, a default used when the transmission source information does not match any determination information 207 is registered.

To the determination value 206, a specific value of an item which is registered to the determination item 204 out of the input content of the permission range information 200 notified from the control program 10 is registered. It should be noted that the value registered to the determination value 206 may indicate a plurality of values using a regular expression or the like.

Returning to FIG. 2, a description is now given of the client approval processing of S100.

The control program 10 determines whether or not the transmission source information matches any one of pieces of the determination information 207 other than the piece of the determination information 207 set as the default in the permission range information 200.

When the transmission source information does not match any one of pieces of the determination information 207 other than the piece of the determination information 207 set as the default in the permission range information 200, based on the information “ON”, which is registered to the operation mode 202 of the entry having the determination item 204 to which the default is registered, the control program 10 determines to insert the operation change script 22 into the Web page 24.

On the other hand, when the transmission source information matches any one of pieces of the determination information 207 of the permission range information 200 other than the piece of the determination information 207 set as the default, the control program 10 determines, based on information registered to the operation mode 202 of the matching entry in the permission range information 200, to prohibit the insertion of the operation change script 22 into the Web page 24.

In the client approval processing of S100, when the transmission source information does not match any one of pieces of the determination information, or when, to the operation mode 202 of an entry matching the transmission source information, ON is registered, the control program 10 determines to insert the operation change script 22 into the Web page 24.

The control program 10 transmits the determination result (operation ON) of the client approval processing carried out in S100 to the script insertion program 12 (S102).

When the script insertion program 12 receives the determination result transmitted in S102, the script insertion program 12 transmits the Web page browsing request to the Web server program 14 (S122).

When the Web server program 14 receives the Web page browsing request, the Web server program 14 selects, out of the Web pages stored in the storage area 100R, the Web page 24 corresponding to the received Web page browsing request, and transmits the selected Web page 24 to the script insertion program 12 (S140).

When the script insertion program 12 receives the Web page 24, the determination result received in S102 is operation ON, and thus the script insertion program 12 carries out script insertion processing of inserting the operation change script 22 into the received Web page 24 (S124).

Then, the script insertion program 12 transmits the Web page 24 into which the operation change script 22 is inserted in S124 to the client device 4 which has transmitted the Web page browsing request (S126).

When the client device 4 receives the Web page 24 transmitted in S126, the script execution program 28 of the Web browser 18 activates the operation change script 22 inserted into the received Web page 24. Then, the activated operation change script 22 changes an operation on the Web page 24 (S220).

It should be noted that an operation change period 30, which is a period in which the operation change script 22 acts on the Web page 24, thereby changing the operation of the Web page 24, is indicated as an rectangle in dotted lines in FIG. 2.

As described above, when, by transmitting a Web page browsing request to the server device 2, the Web page 24 corresponding to the Web page browsing request is transmitted from the server device 2, the client device 4 can browse or can use the Web page 24 corresponding to the Web page browsing request. It should be noted that the server device 2 does not insert, in response to the Web page browsing request for which the insertion of the operation change script 22 is prohibited, the operation change script 22 into the Web page 24, and transmits only the Web page 24 to the client device 4 without inserting the operation change script 22 into the Web page 24, and thus, an error caused by the client device 4 executing the operation changing script 22 or the like can be prevented from occurring on the client device 4.

A description is now given of processing for a case where the permission range information 200 is changed to prohibit execution of the operation change script 22 which has been executed by the client device 4.

First, the management program 16 of the management device 3 transmits an input content of the permission range information 200 input by the administrator to the control program 10 (S160).

When the control program 10 receives the input content of the permission range information 200 transmitted in S160, the control program 10 carries out, based on the input content of the received control information, control information registration processing of updating the permission range information 200 (S104).

In the control information registration processing carried out in S104, when there is an entry having the operation mode 202 to be changed from ON to OFF out of the entries registered to the permission range information 200, namely, when there is a client device 4 or a session for which the operation change script 22 is to be prohibited from being executed, the control program 10 transmits a reload command of reloading a Web page 24 which can be browsed by the Web page browsing program 27 of the Web browser 18 to the client device 4 (S106). On this occasion, the reason for issuing and transmitting the reload command is that, in a current Web browser technology, means of changing the permission of running of a script by means of the reload is most reliable. As the Web technology progresses, if the permission of the running of a script can be controlled or a script can be partially changed by means other than the reload, it is not necessary to limit the processing of S106 to the issue of the reload command. In the following, when the reload is referred to in the embodiments, it is assumed that the permission of the running of the script or the partial change of the script may be realized by alternative means.

Then, when the client device 4 receives the reload command transmitted in S106, the operation change script 22 running on the client device 4 issues the reload command to the Web browser 18 (S222).

When the Web browser 18 receives the reload command issued in S222, the Web browser 18 releases the Web page 24 which is being read, and transmits a Web page browsing request to the server device 2 (S180).

When the reload command is issued by the operation change script 22 in S222, the script execution program 28 releases the operation change script 22, and the operation change period 30 thus ends at this time point.

When the server device 2 receives the Web page browsing request transmitted in S180, the script insertion program 12 inquires, as described above, of the control program 10 whether or not the operation change script 22 is to be inserted into the Web page 24 (S120).

Then, in client approval processing carried out by the control program 10 (S100), on the client device 4 or in the session, the execution of an operation change script 22 is prohibited, namely, OFF is registered to the operation mode 202, and the control program 10 thus determines that the insertion of the operation change script 22 into the Web page 24 is prohibited (operation OFF). Then, the control program 10 transmits the determination result (operation OFF) of the client approval processing carried out in S100 to the script insertion program 12 (S102).

Then, the script insertion program 12 transmits a Web page browsing request to the Web server program 14 in S122. Then, the Web server program 14 transmits the Web page 24 corresponding to the Web page browsing request to the script insertion program 12 in S140.

When the script insertion program 12 receives the Web page 24, the determination result received in S102 is operation OFF, and thus the script insertion program 12 does not insert the operation change script 22 into the received Web page 24 (S124), and transmits the Web page 24 (S126).

Then, when the client device 4 receives the Web page 24 transmitted in S126, the Web browser 18 displays the received Web page 24, thereby bring the Web page into a state in which the user can browse. In this case, the operation change script 22 is not inserted into the Web page 24 received by the client device 4, and the operation change script 22 which the client device 4 has been executing can thus be eliminated.

As described above, when the permission range information 200 is changed, if there is a client device 4 on which the operation change script 22 is prohibited from being executed, the server device 2 immediately transmits the reload command to the client device 4, and the client device 4 which has received the reload command reloads the Web page into which the operation change script 22 is inserted, and transmits the Web page browsing request. Then, the client device 4 receives, in response to the Web page browsing request, the Web page into which the operation change script 22 is not inserted from the server device 2, and thus, after the execution of the operation change script 22 is prohibited, the operation change script 22 can be immediately eliminated from the client device 4.

### Second Embodiment

According to the first embodiment, when the permission range information 200 is changed to prohibit the execution of the operation change script 22 on the client device 4, the server device 2 immediately transmits the reload command to the client device 4, thereby eliminating, from the client device 4, the operation change script 22 that is prohibited from running.

However, in the client device 4, the Web page 24 cannot be always reloaded at a timing when the reload command is received. For example, by the client device 4 reloading the Web page 24, an error that the Web page is transmitted a plurality of times from the server device 2 by the client device 4 reloading the Web page 24, an error that a login session is interrupted between the server device 2 and the client device 4 so that the client device 4 cannot restore the Web page 24 before the reload, or the like occurs.

Therefore, according to the second embodiment, when the state of the Web page 24 displayed on the client device 4 or the state of the user is a state in which the reload is possible, the client device 4 reloads the Web page 24.

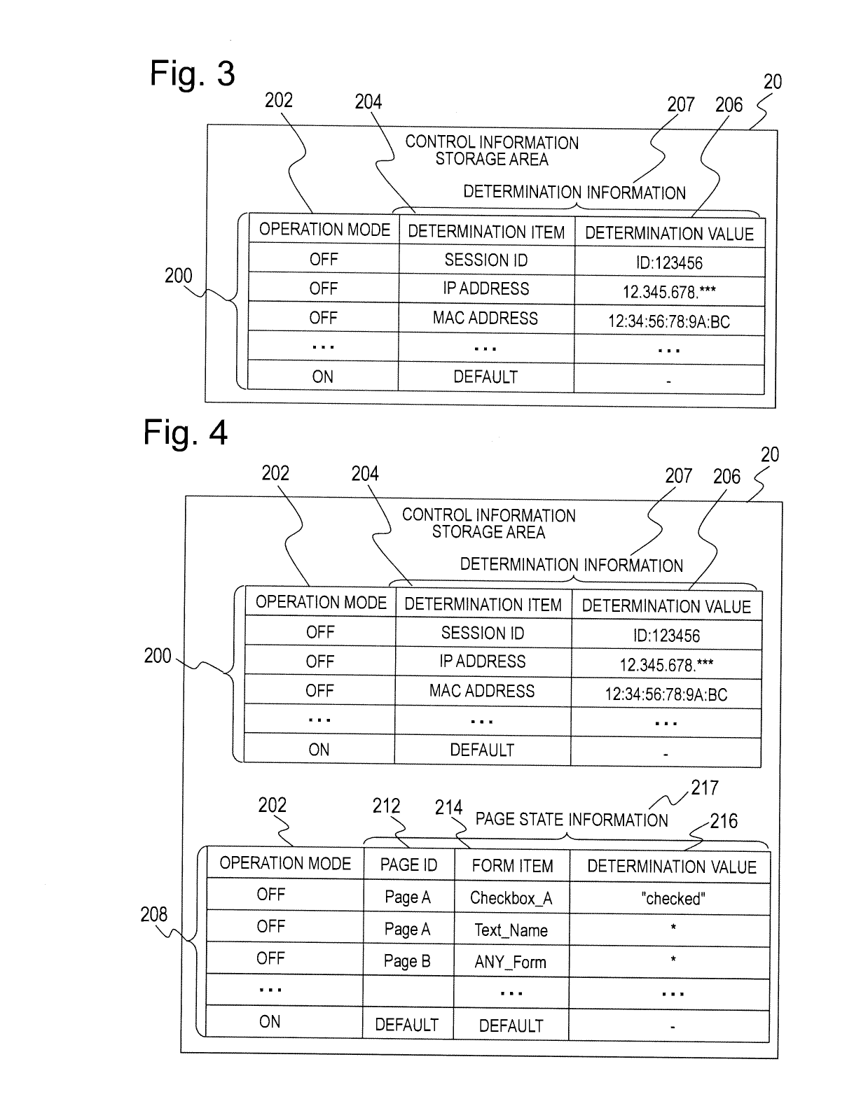

Referring to FIGS. 4 to 6, a description is now given of the second embodiment.

In the control information storage area 20 of the server device 2 according to the second embodiment, in addition to the permission range information 200, reload permission information 208 used for checking whether or not the state of the Web page 24 is the state permitting the reload is stored.

FIG. 4 is an explanatory diagram of the control information storage area 20 according to the second embodiment of this invention.

In the control information storage area 20, the permission range information 200 described in FIG. 3 and the reload permission information 208 are stored.

The reload permission information 208 includes the operation modes 202, page IDs 212, form items 214, and determination values 216. A combination of the page ID 212, the form item 214, and the determination value 216 is referred to as page state information 217.

To the operation mode 202, information indicating whether or not the reload is permitted in a state of the Web page 24 identified by the page state information 217 is registered. When ON is registered to the operation mode 202, this registration indicates that the reload of the Web page 24 is permitted, and when OFF is registered to the operation mode 202, this registration indicates that the reload of the Web page 24 is prohibited.

To the page ID 212, an identifier of a predetermined Web page 24 which can be browsed by the Web browser 18 of the client device 4 is registered. The identifier of the Web page 24 registered to the page ID 212 may be, for example, an identifier of a file name or a URI of the Web page 24, or an identifying symbol of the Web page 24 uniquely defined by the server device 2.

To the form item 214, an identifier of a form item in the Web page 24 which can be changed by the user is registered. The identifier of the form item of the Web page 24 which is registered to the form item 214 may be an identifier included in each form item, an address indicating a node position in a tree structure of nodes constituting the Web page 24, or the like.

Moreover, in order to specify all form items in the Web page 24, “ANY_Form” may be registered to the form item 214. Further, in order to specify a plurality of form items in the Web page 24, an identifier indicated by the regular expression or the like may be registered to the form item 214.

Information registered to the determination value 216 is information indicating a value input to the form item determined by the page ID 212 and the form item 214. The information registered to the determination value 216 may be information specifying a specific value or information specifying various values by using the regular expression.

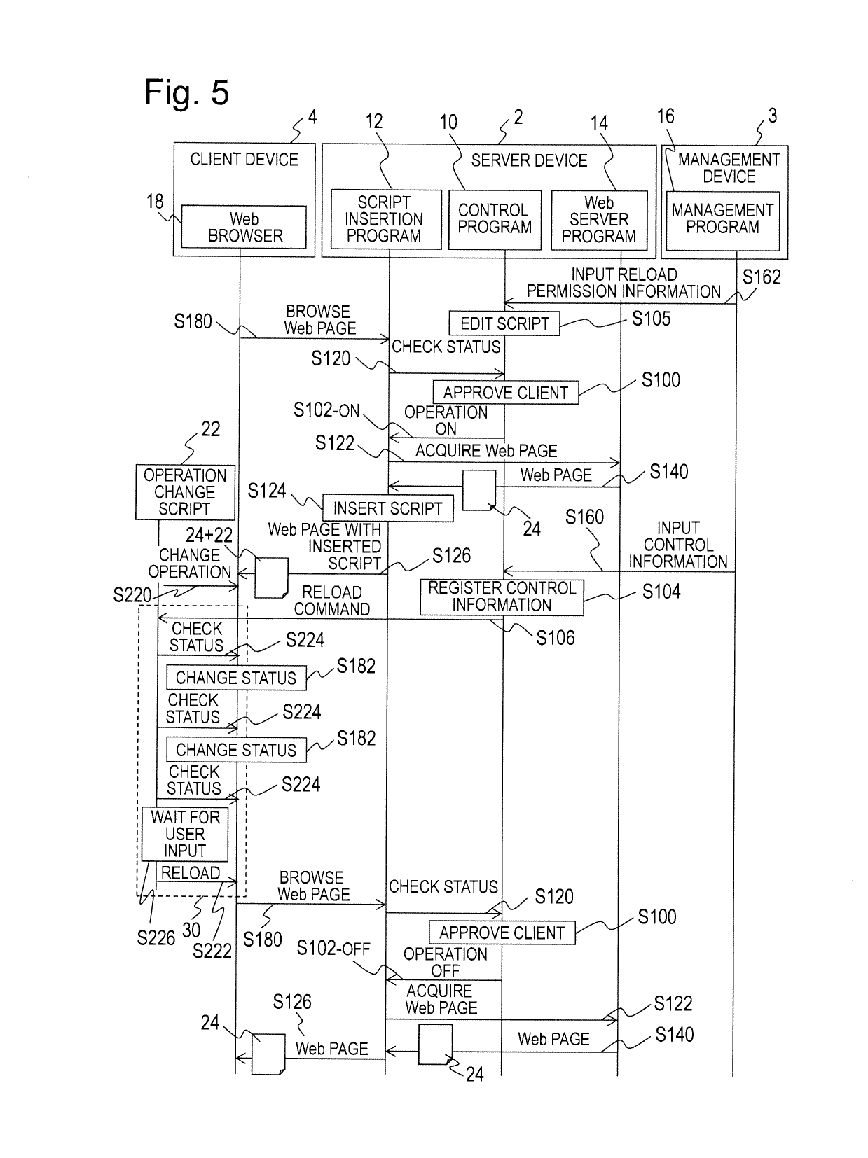

FIG. 5 is a sequence diagram for the Web page supplying processing in the Web page supplying system 1 according to the second embodiment of this invention. Of the processing in FIG. 5, the same processing steps as in the Web page supplying processing according to the first embodiment illustrated in FIG. 2 are denoted by the same reference symbols, and the description thereof is omitted.

First, the management program 16 in the management device 3 transmits reload permission information including an input content of the reload permission information 208 input by the administrator to the control program 10 of the server device 2 (S162).

When the control program 10 receives the reload permission information transmitted in S162, the control program 10 updates the reload permission information 208 based on the received reload permission information. Then, the operation change script 22 to be transmitted to the client device 4 contains the reload permission information 208 after the update, and is transmitted, and the control program 10 thus changes a logic relating to the reload of the operation change script 22 (S105).

Processing after the Web browser 18 of the client device 4 transmits a Web page browsing request to the server device 2, and until the script insertion program 12 transmits a Web page 24 to the client device 4 (S180, S120, S100, S102-ON, S122, S140, S124, and S126) is the same as in the Web page supplying processing illustrated in FIG. 2, and a description thereof is therefore omitted.

It should be noted that, in S126, the operation change script 22 to be inserted into the Web page 24 to be transmitted from the script insertion program 12 contains the reload permission information 208.

Moreover, the processing after the management program 16 transmits an input content input by the administrator of the control information storage area 20 to the server device 2 until the control program 10 transmits the reload command to the client device 4 (S160, S104, and S106) is the same as in the Web page supplying processing illustrated in FIG. 2, and a description thereof is therefore omitted.

When the client device 4 receives the reload command transmitted in S106, the operation change script 22 running on the client device 4 does not immediately issue the reload command, and checks whether or not a state of the Web page 24 which can be browsed by the Web page browsing program 27 is in the reloadable state (S224).

Specifically, the operation change script 22 selects entries each having an identifier of a Web page registered to the page ID 212 of the reload permission information 208 included in the operation change script 22 which matches an identifier of the Web page 24 which can be browsed by the Web page browsing program 27. Then, the operation change script 22 determines whether or not there are entries each having a value registered to the determination value 216 which matches a value input to a form item (corresponding form item) identified by an identifier registered to the form item 214 of each of the selected entries out of form items which are included in the Web page 24 which can be browsed by the Web page browsing program 27.

Then, when it is determined that there are entries each having a value input to the corresponding form item which matches the value registered to the determination value 216, the operation change script 22 acquires information registered to the operation mode 202 of those entries. Then, when all pieces of the acquired information registered to the operation modes 202 are ON, namely when OFF is registered to none of the acquired operation modes 202, the operation change script 22 determines that the Web page 24 which can be browsed by the Web page browsing program 27 can be reloaded, and issues the reload command to the Web browser 18 (S222).

When OFF is registered to any one of the acquired operation modes 202, the operation change script 22 prohibits the Web page 24 which can be browsed by the Web page browsing program 27 from being reloaded, and, for example, each time the state of the Web page 24 is changed by an input from the user (S182), checks whether or not the state of the Web page 24 is reloadable (S224).

On the other hand, when the operation change script 22 determines that there is no entry having a value input to the corresponding form item which matches the value registered to the determination value 216, the operation change script 22 acquires the information (ON) registered to the operation mode 202 of the entry whose page state information 217 is default in the reload permission information 208. Accordingly, the operation change script 22 determines that the Web page 24 which can be browsed by the Web page browsing program 27 can be reloaded, and issues the reload command to the Web browser 18 (S222).

In FIG. 5, in a first state check, it is determined that the state of the Web page 24 is not reloadable. Even after the state of the Web page 24 is changed for the second time, it is still determined that the state of the Web page 24 is not reloadable state. Then, after the state of the Web page 24 is changed for the second time, it is determined that the state of the Web page 24 is the reloadable state, and the reload command is thus issued (S222).

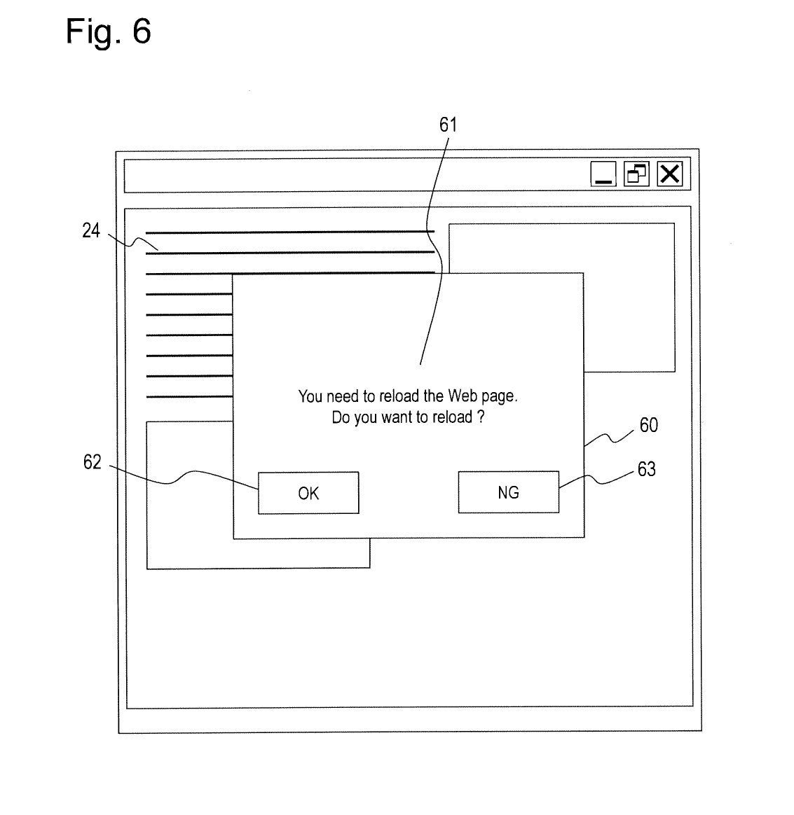

Even if, in S224, it is determined that the state of the Web page 24 is the reloadable state, the operation change script 22 may display a reload permission interface 60 (refer to FIG. 6) for receiving an input indicating permission of the reload of the Web page 24 by the user on a display device (not shown) provided for the client device 4 (S226), and, until the input indicating the permission of the reload of the Web page 24 by the user is received, may suspend the reload of the Web page 24.

FIG. 6 is an explanatory diagram of the reload permission interface 60 according to the second embodiment of this invention.

The reload permission interface 60 is displayed as a dialog window on a layer on the Web page 24 displayed by the Web browser 18.

The reload permission interface 60 includes a message portion 61 for asking the user whether or not to permit the reload of a Web page 24, an OK button 62 for receiving an input of the reload permission by the user, and an NG button 63 for receiving an input of the reload refusal by the user.

As a result, when the permission range information 200 is changed, if there is a client device 4 on which the execution of the operation change script 22 is prohibited, the server device 2 immediately transmits the reload command to the client device 4, but the client device 4 does not reload a Web page 24 until the state of a Web page 24 becomes the reloadable state, and hence the error of transmission of the Web page 24 a plurality of times from the server device 2 can be prevented from occurring. Further, it is possible to prevent a problem in that the client device 4 reloads the Web page 24, thereby interrupting a login session between the server device 2 and the client device 4, resulting in an error in which the client device 4 cannot restore a Web page before the reload, or the like from occurring.

### Third Embodiment

According to the second embodiment, even in a case where the client device 4 receives the reload command, when the state of a Web page 24 which is being browsed by a Web browser 18 is not the reloadable state, the Web page 24 is not reloaded.

However, there is a Web page 24 for which the reloadable state cannot be defined in the reload permission information 208, and hence a system on which the user can explicitly deny the reload of the Web page 24 is needed.

Thus, according to the third embodiment, an operation change script 22 provides the Web browser 18 with an interface for receiving an input by the user which indicates whether the reload of a Web page 24 is permitted or refused, and when the user does not permit the reload of the Web page 24, the server device 2 prohibits the change in the permission range information 200 by the management program 16. Therefore, the reload command transmitted by the server device 2 when the permission range information 200 is changed, is not received if the user does not permit the reload of the Web page 24, and thus, if the user does not permit the reload of the Web page 24 in advance, the client device 4 does not receive the reload command. As a result, even if there is a Web page 24 whose reloadable state cannot be defined in the reload permission information 208, the reload of the Web page 24 can be prohibited for a period required by the user.

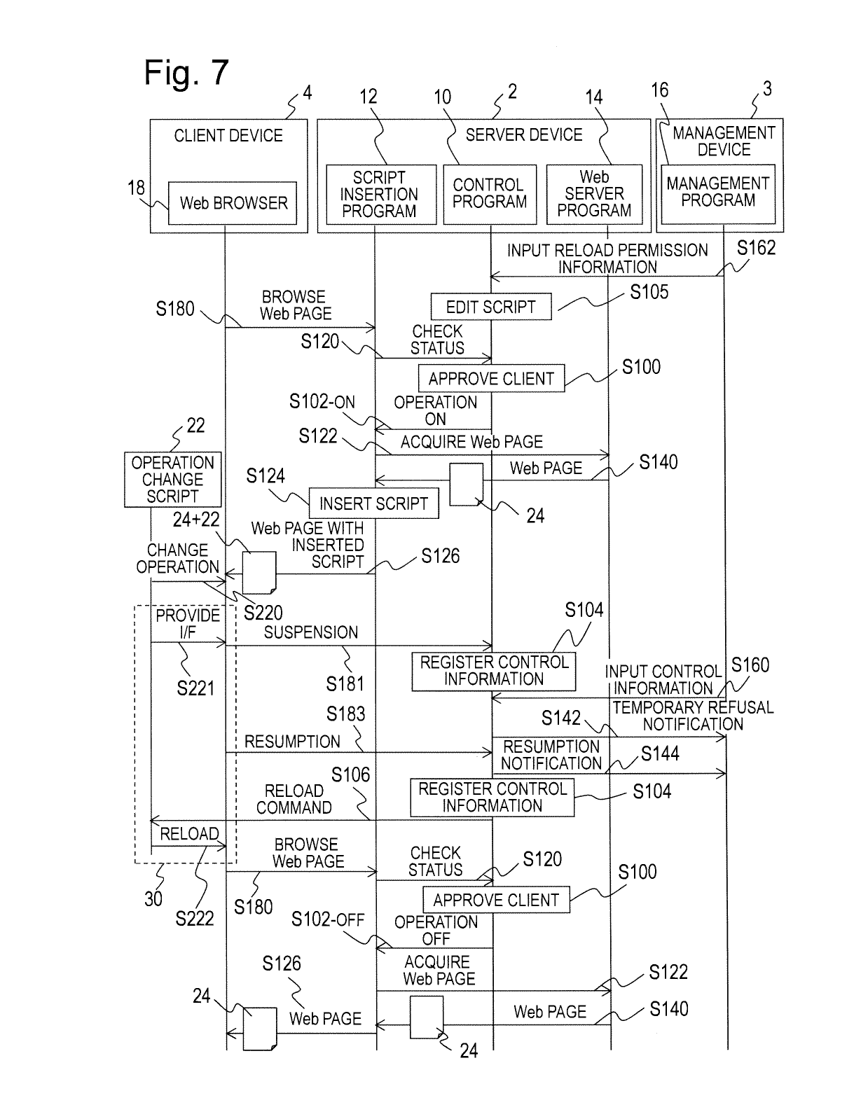

FIG. 7 is a sequence diagram for the Web page supplying processing in the Web page supplying system 1 according to the third embodiment of this invention.

Processing after the management program 16 of the management device 3 transmits reload permission information to the control program 10 of the server device 2 until the script insertion program 12 transmits the Web page 24 to the client device 4 (S162, S105, S180, S120, S100, S102-ON, S122, S140, S124, and S126) is the same as in the Web page supplying processing illustrated in FIG. 5, and a description thereof is therefore omitted.

The operation change script 22 changes an operation of the Web page 24 loaded by the Web browser 18 (S220), and displays a reload control interface (not shown) on the display device (not shown) provided to the client device 4, thereby providing the reload control interface (S221).

The reload control interface is an interface for receiving an input indicating whether or not the reload of the Web page 24 is permitted. If HTML is used for the Web page 24, the reload control interface may be indicated by inserting, by using the “A” tag, a link into the Web page 24, or indicated by the “button” contained in a form item constituting the Web page 24.

When the user inputs, via the reload control interface, the refusal of the reload of the Web page 24, the Web browser 18 transmits temporary stop information for notifying of the refusal of the reload of the Web page 24 to the control program 10 of the server device 2 (S181).

When the control program 10 receives the temporary stop information, the control program 10 stores information indicating that the permission range information 200 is not to be updated in the control information storage area 20 (S104).

On this occasion, the management program 16 of the management device 3 transmits an input content of the permission range information 200 input by the administrator to the control program 10 (S160).

Even if the control program 10 receives the input content of the permission range information 200, the information indicating that the permission range information 200 is not to be updated is stored in the control information storage area 20, and hence the control program 10 transmits, to the client device 4 or the session for which the update of the permission range information 200 and the execution of an operation change script 22 are prohibited, a temporary refusal notification indicating that the transmission of the reload command is temporarily prohibited to the management program 16 (S142).

Then, when the user inputs, via the reload control interface, the permission of the reload of the Web page 24, the Web browser 18 transmits resumption information for notifying the permission of the reload of the Web page 24 to the control program 10 (S183).

When the server device 2 receives the resumption information, the server device 2 deletes the refusal of the update of the permission range information 200 which is stored in the control information storage area 20 in S104, and transmits a resumption notification indicating that the update of the permission range information 200 is enabled to the management program 16 (S144).

Then, the control program 10 updates, based on input content of the permission range information 200 received in the period in which the permission range information 200 is not updated, the permission range information 200 (S104), and transmits the reload command to the client device 4 for which the operation change script 22 is prohibited from being executed (S106).

The processing after the control program transmits the reload command 10 until the script insertion program 12 transmits the Web page 24 (S106, S222, S180, S120, S100, S102-OFF, S122, S140, and S126) is the same as in the Web page supplying processing illustrated in FIG. 2, and a description thereof is therefore omitted.

As a result, while the user prohibits the reload of Web pages 24, the permission range information 200 is not updated, and hence the reload command is not transmitted to the client device 4. Accordingly, even if there is a Web page 24 having the reloadable state which cannot be defined in the reload permission information 208, the Web page 24 can be prohibited from being reloaded during a period required by the user.

### Fourth Embodiment

According to the first to third embodiments, the control program 10 of the server device 2 actively transmits the reload command to the operation change script 22 running on the client device 4.

In order for the server device 2 to transmit the reload command to the client device 4, the server device 2 has to recognize the sessions between the server device 2 and all the client devices 4 coupled to the server device 2. However, in a large scale system in which a large number of client devices 4 are coupled to the server device 2, the recognition of the sessions between the server device 2 and all the client devices 4 coupled to the server device 2 imposes a high load on the server device 2.

Then, according to this embodiment, by a client device 4 periodically transmitting information to the server device 2, a server device 2 transmits, based on the information transmitted from the client device 4, the reload command to the client device 4.

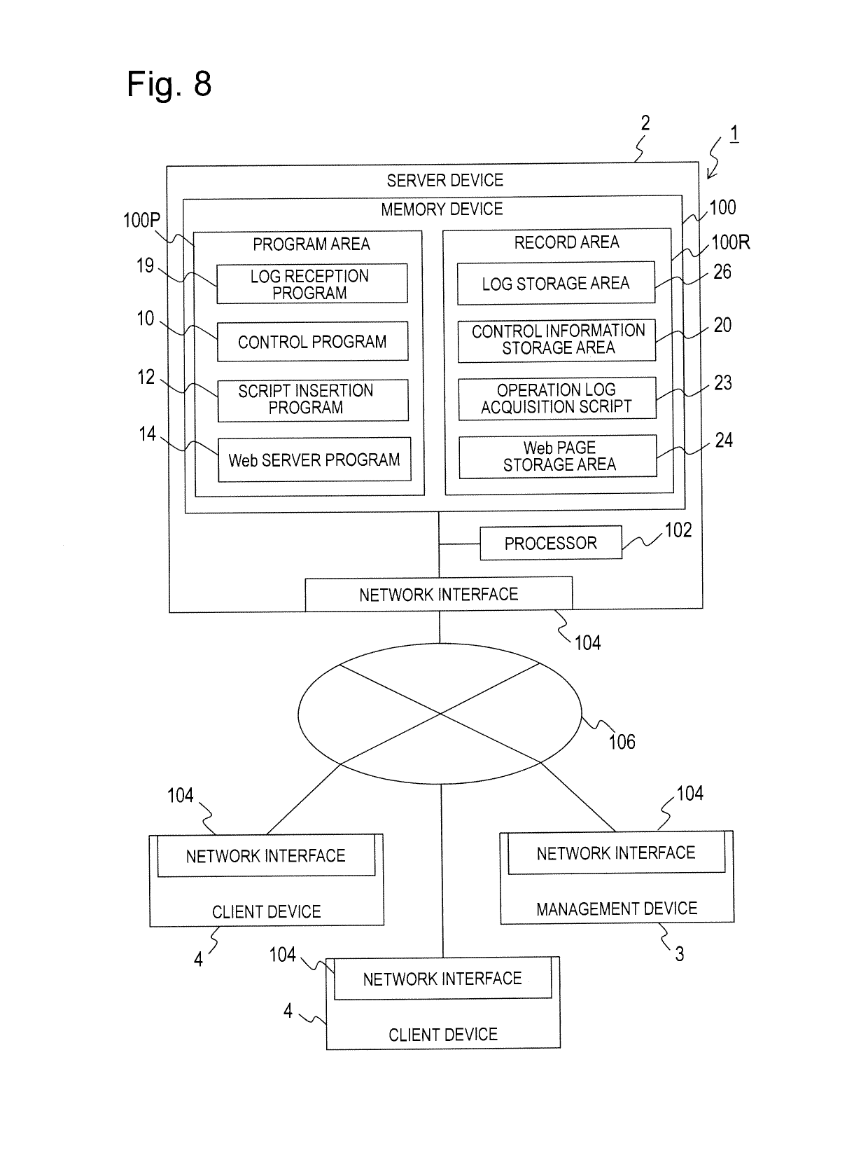

Referring to FIGS. 8 to 10, a description is now given of the fourth embodiment.

FIG. 8 is an explanatory diagram of a configuration of the Web page supplying system 1 according to the fourth embodiment of this invention.

The management device 3 and the client devices 4 have the same configuration as in the management device 3 and the client devices 4 illustrated in FIG. 1, and a description thereof is therefore omitted.

The server device 2, in the same manner as in the server device 2 illustrated in FIG. 1, includes a memory device 100, a processor 102, and a network interface 104, but the server device 2 is different from the server device 2 illustrated in FIG. 1 in the information stored in the memory device 100.

Specifically, in a program area 100P of the memory device 100, in addition to a control program 10, a script insertion program 12, and a Web server program 14, a log reception program 19 is stored. In a storage area 100R of the memory device 100, in addition to a control information storage area 20 and a Web page 24, a log storage area 26 is stored. Moreover, in the storage area 100R of the memory device 100, in place of the operation change scripts 22, operation log acquisition scripts 23 are stored.

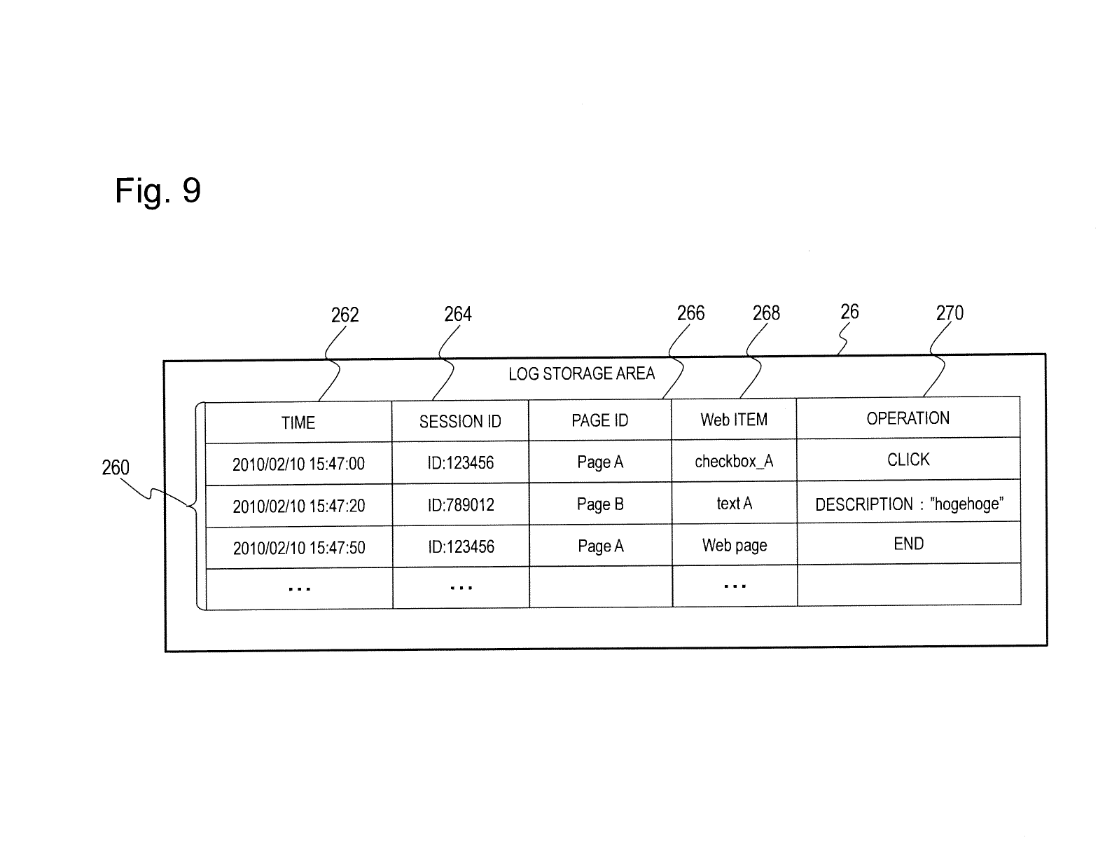

The operation log acquisition script 23, in the same manner as in the operation change script 22, changes an operation of the Web page 24 displayed by a Web browser 18 of the client device 4, but the operation log acquisition script 23 acquires an operation log of the user on the Web page, and transmits the acquired operation log as operation log information 260 (refer to FIG. 9) to the server device 2.

The log reception program 19 stores the operation log information 260 by the operation log acquisition script 23 in the log storage area 26.

FIG. 9 is an explanatory diagram of the log storage area 26 according to the fourth embodiment of this invention.

In the log storage area 26, the operation log information 260 whose one record is constituted by an operation time 262, a session ID 264, a page ID 266, a Web item 268, and an operation 270 is stored.

To the operation time 262, information of time at which an operation has occurred is registered. The time information registered to the operation time 262 according to this embodiment includes, a year, a month, a date, and a time, but the time information is not limited to this, and may be an offset from a certain time, and, if needed, millisecond, or microsecond may be included in the time information.

To the session ID 264, an identifier of a session maintained between the client device 4 executing the Web browser 18 on which the operation has been carried out and the server device 2 is registered.

To the page ID 266, an identifier of the Web page 24 on which the operation has been carried out is registered.

To the Web item 268, an identifier of a form item subject to the operation on the Web page 24 is registered.

To the operation 270, an identifier of an operation content is registered. The operation content includes, for example, an operation by the user such as click and key-down, a string described in a text form, and a global operation such as closure of a Web page 24.

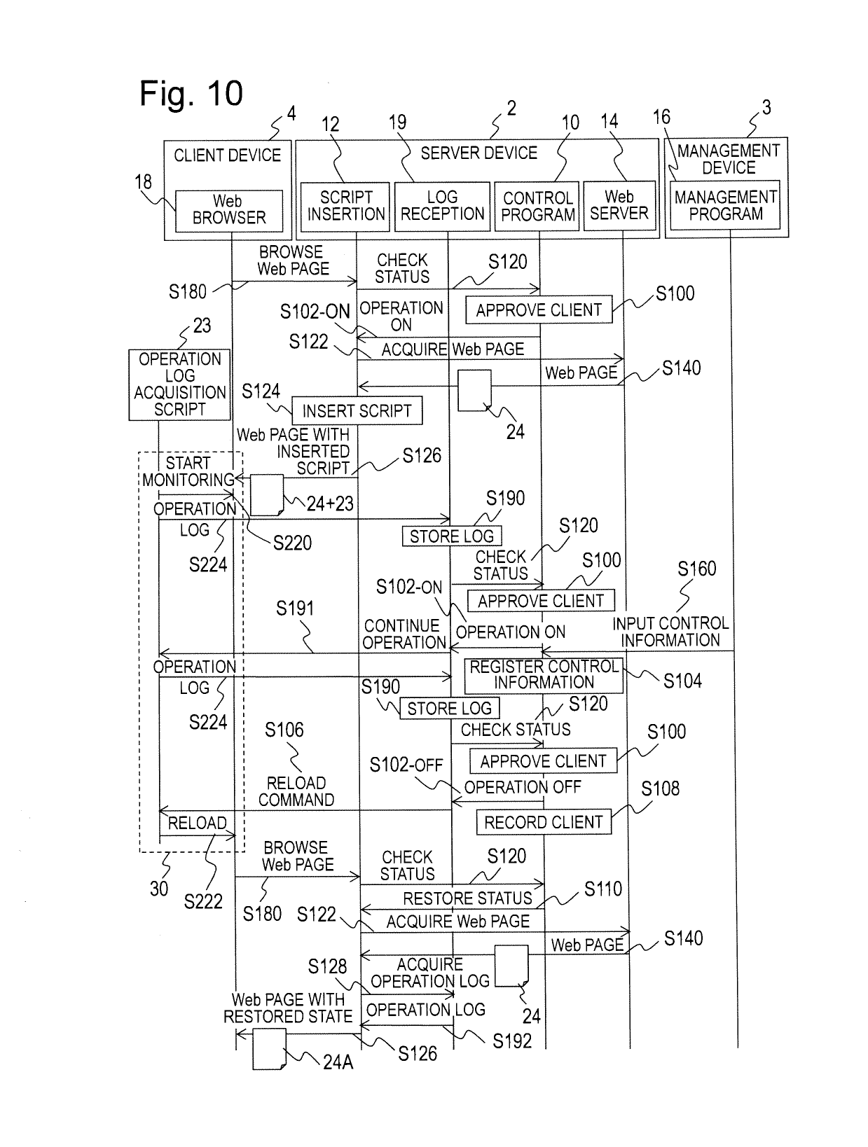

FIG. 10 is a sequence diagram for the Web page supplying processing in the Web page supplying system 1 according to the fourth embodiment of this invention.

Processing after the Web browser 18 of the client device 4 transmits a Web page browsing request to the server device 2 until the script insertion program 12 transmits the Web page 24 into which the operation log acquisition script 23 is inserted to the client device 4 (S180, S120, S100, S102-ON, S122, S140, S124, and S126) is the same as in the Web page supplying processing illustrated in FIG. 2, and a description thereof is therefore omitted.

The operation log acquisition script 23 is activated by a script execution program 28 of the Web browser 18, and starts to monitor the operation of the user on the Web browser 18 (S220).

The operation log acquisition script 23 transmits the operation log information 260 indicating operations of the user on the Web browser 18 to the log reception program 19 of the server device 2 repeatedly in a predetermined timing (S224).

The operation log information 260 includes time information, session IDs, Web page IDs, form items, and operation contents.

The timing at which the operation log information 260 is transmitted may be determined, for example, by a method of using a timing at which a predetermined period has elapsed from the transmission of the operation log information 260 last time, a timing at which pieces of the operation log information 260 are accumulated to a predetermined quantity on the client device 4, or a timing at which a predetermined periodic operation of the user is detected, or may be determined by a method of detecting a typical operation generated periodically or by such other method.

When the log reception program 19 receives the operation log information 260, the log reception program 19 stores the received operation log information 260 in the log storage area 26 (S190).

Then, the log reception program 19 inquires of the control program 10 whether or not the operation log acquisition script 23 is controlled to continue the detection of the operation log, namely, whether or not the execution of the operation log acquisition script 23 is prohibited on the client device 4 (S120). This inquiry request includes the session ID contained in the received operation log information 260 or identification information on the client device 4 such as a network address derived based on the session ID.

When the control program 10 receives the inquiry of S120, the control program 10 refers to the identification information on the client device 4 included in the inquiry in S120 and the permission range information 200 stored in the control information storage area 20, thereby determining whether or not to control the operation log acquisition script 23 to continue the detection of the operation log (S100).

In the determination processing of S100, when ON is registered to the operation mode 202 of an entry which is registered to the permission range information 200 illustrated in FIG. 3 and has determination information 207 matching the identification information, the control program 10 determines to control the operation log acquisition script 23 to continue the detection of the operation log, but when OFF is registered to the operation mode 202 of the entry, the control program 10 determines to control the operation log acquisition script 23 not to continue the detection of the operation log.

In S100, in this case, it is assumed that the operation log acquisition script 23 is controlled to continue the detection of the operation log.

Then, the control program 10 transmits the determination result (operation ON) of S100 to the log reception program 19 (S102-ON).

When the log reception program 19 receives the determination result (operation ON) of S100, the log reception program 19 transmits an operation continuation signal indicating that the operation log acquisition script 23 is controlled to continue the detection of the operation log, as a response to the operation log information 260 transmitted by the operation log acquisition script 23 in S224, to the operation log acquisition script 23 (S191).

On this occasion, the management program 16 of the management device 3 transmits an input content of the permission range information 200 input by the administrator to the control program 10 (S160), and the control program 10 updates, based on the input content of the received permission range information 200, the permission range information 200 (S104).

On this occasion, in the permission range information 200 updated in S104, the acquisition of the operation log by the operation log acquisition script 23 of the client device 4 which has transmitted the Web browsing request in S180 is prohibited, but the control program 10 does not transmit the reload command.

Moreover, the operation log acquisition script 23 transmits second operation log information 260 to the log reception program 19 (S224).

When the log reception program 19 receives the operation log information 260, the log reception program 19 stores the received operation log information 260 in the log storage area 26 (S190), and inquires of the control program 10 whether or not the operation log acquisition script 23 is controlled to continue the detection of the operation log (S120).

The control program 10 refers to the permission range information 200 and determines to prohibit the operation log acquisition script 23 from detecting the operation log (S100).

Then, the control program 10 transmits the determination result (operation OFF) of S100 to the log reception program 19 (S102-OFF), and stores identification information (such as a session ID or an IP address) on the client device 4 on which an operation log acquisition script 23 is prohibited (S108).

When the log reception program 19 receives the determination result, the operation log acquisition script 23 is prohibited from detecting the operation log, and thus, the log reception program 19 transmits the reload command as a response to the operation log information 260 transmitted by the operation log acquisition script 23 in S224, to the operation log acquisition script 23 of the client device 4 (S106).

Then, when the client device 4 receives the reload command transmitted in S106, the operation log acquisition script 23 running on the client device 4 issues the reload command to the Web browser 18 (S222).

When the Web browser 18 receives the reload command issued in S222, the Web browser 18 releases the Web page 24 which is being read, and transmits a Web page browsing request to the server device 2 (S180).

When the server device 2 receives the Web page browsing request transmitted in S180, the script insertion program 12 inquires of the control program 10 whether or not an operation log acquisition scripts 23 is to be inserted into the Web page 24 and whether or not the Web page 24 is to be restored (S120).

In the permission range information 200, the execution of an operation log acquisition script 23 is prohibited on the client device 4. Accordingly, the control program 10 determines to prohibit the insertion of an operation log acquisition script 23 into the Web page 24, and determines whether or not the identification information on the client device 4 which has transmitted the Web page browsing request is stored in S108. On this occasion, the identification information is stored, and the control program 10 thus determines to restore the operations by the user on the Web page 24, and to transmit the restored Web page 24. Then, the control program 10 transmits the determination result to the script insertion program 12 (S110). When the identification information is not stored, the control program 10 determines to transmit, without restoring the operations by the user on the Web page 24, the Web page 24.

Then, the script insertion program 12 transmits the received Web page browsing request to the Web server program 14 (S122). Then, the Web server program 14 transmits the Web page 24 corresponding to the Web page browsing request to the script insertion program 12 (S140).

When the script insertion program 12 receives the Web page 24, the script insertion program 12 transmits, in order to acquire operation log information 260 on the Web page 24 and to thereby restore the operations by the user on the Web page 24, an operation log information acquisition request to the log reception program 19 (S128). The operation log information acquisition request includes the page ID of the Web page 24 and the session ID between the client device 4 which has transmitted the Web page browsing request and the server device 2.

When the log reception program 19 receives the operation log information acquisition request, the log reception program 19 transmits, out of the operation log information 260 stored in the log storage area 26, operation log information 260 having a session ID 264 and a page ID 266 which match the session ID and the page ID included in the received operation log information acquisition request, to the script insertion program 12 (S192).

When the script insertion program 12 receives the operation log information 260, the script insertion program 12 restores, based on the Web items 268 and the operations 270 of the received operation log information 260, the operations by the user on the Web page 24, and transmits a Web page 24A on which the operations of the user are restored to the Web browser 18 of the client device 4 (S126).

As a result, the server device 2 does not always need to maintain a session to the client devices 4, and the load imposed on the server device 2 can be reduced. Moreover, even if the Web browser 18 reloads the Web page, a Web page 24A on which operations by the user on the Web page 24 are restored is transmitted to the Web browser 18, and hence a situation in which the user browsing the Web page 24 has to carry out the same input again after the reload of the Web page 24 can be avoided.

This invention has been described in detail with reference to the accompanying drawings, but is not limited to those concrete configurations, and encompasses various modifications and equivalent configurations within the spirit of the scope of claim set forth below.

What is claimed is:

1. A Web page supplying system, comprising:
a Web server for supplying a Web page by transmitting the Web page to a client device; and
a management server for managing the Web server, wherein:
the Web server stores control information indicating whether to insert additional information into the Web page requested by the client device, and includes:
a Web page supplying module for supplying the Web page by transmitting the Web page requested by the client device to the client device;
an additional information insertion module for inserting the additional information into the Web page requested by the client device; and
a control module for controlling the additional information insertion module;
the management server includes a management module for editing the control information stored in the Web server; and
the control module is configured to:
determine, by referring to the control information, whether to insert the additional information into the Web page to be transmitted to the client device requesting the Web page; and
control, in a case where it is determined that the additional information is not to be inserted into the Web page, the additional information insertion module so as not to insert the additional information into the Web page.

2. The Web page supplying system according to claim 1, wherein:
the client device includes:
a Web page browsing module for displaying the Web page transmitted from the Web server; and
an additional information insertion module for interpreting the additional information transmitted from the Web server to execute processing based on the additional information;
in a case where the control information is changed so as to indicate that the additional information is not to be inserted into the Web page, the Web server transmits, to the client device, a reload command for causing reloading of the Web page changed by the changed control information so as to indicate that the additional information is not to be inserted; and
in a case where the client device receives the reload command, the client device reloads, based on the additional information interpreted by the additional information interpretation module, the Web page displayed by the Web page browsing module.

3. The Web page supplying system according to claim 2, wherein the client device transmits predetermined information in a predetermined timing to the Web server, based on the additional information interpreted by the additional information interpretation module.

4. The Web page supplying system according to claim 3, wherein in a case where the Web server receives the predetermined information transmitted from the client device, the Web server updates a state of the Web server itself based on the received predetermined information.

5. The Web page supplying system according to claim 3, wherein in a case where the Web server receives the predetermined information transmitted from the client device, the Web server transmits reply information indicating a reply to the received predetermined information to the client device.

6. The Web page supplying system according to claim 3, wherein the client device transmits, based on the additional information interpreted by the additional information interpretation module, operation history information indicating operation history of a user on the Web page displayed by the Web page browsing module as the predetermined information in the predetermined timing to the Web server.

7. The Web page supplying system according to claim 6, wherein the Web server stores the operation history information transmitted from the client device.

8. The Web page supplying system according to claim 7, wherein the Web page supplying module is configured to:
generate, in a case where the Web page is reloaded on the client device, based on the operation history information, a Web page on which the operation history of the user before the reload on the Web page subject to the reload is restored; and
transmit the generated Web page to the client device.

9. The Web page supplying system according to claim 1, wherein the Web server and the management server are implemented on the same computer.

10. A Web page supplying method for use in a Web page supplying system including a Web server for supplying a Web page by transmitting the Web page to a client device, and a management server for managing the Web server, the Web server and the client device being coupled via a network,
the Web server storing control information indicating whether to insert additional information into the Web page requested by the client device,
the Web page supplying method including:
a Web page supplying step of supplying, by the Web server, the Web page by transmitting the Web page requested by the client device to the client device;
an additional information insertion step of inserting, by the Web server, the additional information into the Web page requested by the client device; and
a management step of editing, by the management server, the control information stored in the Web server,
wherein the additional information insertion step includes the steps of:
determining, in a case where a request is received from the client device, by referring to the control information, whether the additional information is to be inserted into the Web page to be transmitted to the client device which is a transmission source of the request; and
restraining, in a case where it is determined that the additional information is not to be inserted into the Web page, the additional information from being inserted into the Web page.

11. The Web page supplying method according to claim 10, further including:
a Web page browsing step of displaying, by the client device, the Web page transmitted from the Web server, and
an additional information interpretation step of interpreting, by the client device, the additional information transmitted from the Web server to execute processing based on the additional information;
a reload command transmission step of transmitting, by the Web server, in a case where the control information is changed so as to indicate that the additional information is not to be inserted into the Web page, to the client device, a reload command for causing reloading of the Web page for which the changed control information is changed so as to indicate that the additional information is not to be inserted; and
a step of reloading, by the client device, in a case where the client device receives the reload command, based on the additional information interpreted in the additional information interpretation step, the Web page displayed in the Web page browsing step, and transmitting, by the client device, a request for the Web page for which the reload has been completed to the Web server.

12. The Web page supplying method according to claim 11, further including an information transmission step of transmitting, by the client device predetermined information in a predetermined timing to the Web server, based on the additional information interpreted in the additional information interpretation step.

13. The Web page supplying method according to claim 12, further including a state update step of updating, by the Web server, in a case where the Web server receives the predetermined information transmitted from the client device, a state of the Web server itself based on the received predetermined information.

14. The Web page supplying method according to claim 13, further including transmitting, by the Web server, in a case where the Web server receives the predetermined information transmitted from the client device, reply information indicating a reply to the received predetermined information to the client device.

15. The Web page supplying method according to claim 12, wherein, in the information transmission step, the client device transmits, based on the additional information interpreted in the additional information interpretation step, operation history information indicating operation history of a user on the Web page displayed in the Web page browsing step as the predetermined information in the predetermined timing to the Web server.

16. The Web page supplying method according to claim 15, further including an operation history information storing step of storing, by the Web server, the operation history information transmitted from the client device.

17. The Web page supplying method according to claim 16, wherein the Web page supplying step comprises:
generating, in a case where the Web page is reloaded on the client device, based on the operation history information, a Web page on which the operation history of the user before the reload on the Web page for which the reload has been completed is restored; and
transmitting the generated Web page to the client device.

18. The Web page supplying method according to claim 10, wherein the Web server and the management server are configured to be implemented on the same computer.

19. A storage medium having stored thereon a control program for controlling, in a Web page supplying system including a Web server for supplying a Web page by transmitting the Web page to a client device, and a management server for managing the Web server, the Web server and the client device being coupled via a network, the Web server to determine whether to insert additional information into the Web page,
the Web server storing control information indicating whether to insert additional information into the Web page requested by the client device, and including:
a Web page supplying module for supplying the Web page requested by the client device; and
an additional information insertion module for inserting the additional information into the Web page requested by the client device,
the management server including a management module for editing the control information stored in the Web server,
the control program controlling the additional information insertion module for controlling the Web server to determine whether to insert additional information, and the control program including the procedures of:
controlling, in a case where the Web server receives a request from the client device, by referring to the control information, the Web server to determine whether to insert the additional information into a Web page to be transmitted to the client device which is a transmission source of the request; and
controlling, in a case where it is determined that the additional information is not to be inserted into the Web page, the Web server to control the additional information insertion module so as not to insert the additional information into the Web page.
